(19) United States
(12) Patent Application Publication
(10) Pub. No.: US 2024/0093972 A1
(43) Pub. Date: Mar. 21, 2024

(54) FIBER-REINFORCED COMPOSITE MATERIAL AND METHOD AND PLANT FOR THE PRODUCTION THEREOF

(71) Applicant: SAATI S.P.A., Appiano Gentile (IT)

(72) Inventors: Franco MERLETTI, Appiano Gentile (IT); Thomas DELLA VEDOVA, Appiano Gentile (IT); Carmine LUCIGNANO, Appiano Gentile (IT); Paolo CANONICO, Appiano Gentile (IT)

(21) Appl. No.: 18/263,721

(22) PCT Filed: Mar. 8, 2022
(86) PCT No.: PCT/IB2022/052039

§ 371 Date: Aug. 1, 2023

(30) Foreign Application Priority Data
Mar. 10, 2021 (IT) 102021000005618

(51) Int. Cl. F41H 5/04; B32B 5/02; B32B 5/26; D06M 15/00; D06M 23/08; D06M 23/16

(52) U.S. Cl. CPC F41H 5/0485; B32B 5/024; B32B 5/263; D06M 15/00; D06M 23/08; D06M 23/16; B32B 2250/05; B32B 2250/20; B32B 2260/023; B32B 2260/046; B32B 2262/0269; B32B 2262/16; B32B 2437/04; B32B 2571/02; D06M 2101/36

(57) ABSTRACT

A fiber-reinforced composite material, consisting of an amorphous thermoplastic matrix distributed over a surface of an aramid fabric and forming a surface thermoplastic film partially interpenetrated with and adhering to the aramid fabric. The production method comprises the steps of: unwinding an aramid fabric on conveyor means; distributing a thermoplastic matrix in the form of micrometric powder over the whole upper surface of the aramid fabric as it is unwound; passing the material through a first hot section and then through a second relatively cold section; the first section applies a temperature and a pressure such as to form a surface thermoplastic film on the fabric; the second section facilitates detachment of the coated material from the conveyor means. The plant comprises a conveyor belt on which an aramid fabric is unwound; a powder scattering station adapted to distribute a thermoplastic matrix in the form of micrometric powder on the aramid fabric as it is unwound on the conveyor belt; a system of double belts in contact through which the fabric is conveyed; the system of double belts in contact defines a first hot section and a second relatively cold section; the first section applies a temperature and a pressure functional to the formation of a surface thermoplastic film on the fabric; the second section facilitates detachment of the fabric.

### BACKGROUND OF THE INVENTION

The present invention concerns a protective fiber-reinforced composite material and the method and plant for the production thereof.

More in particular, the present invention concerns a pre-impregnated fiber-reinforced composite material, a so-called “pre-preg”, used as a base for the production of articles provided with ballistic protection, particularly for hard armoring of vehicles and the production of ballistic helmets.

The field of armoring is characterized by the use of a wide range of ballistic materials, often used in combination with one another, such as ballistic steel, ceramics, aramid and/or polyethylene fabrics.

Said solutions, which can be defined “hybrid”, concern in particular levels of armoring comprising protection against armor-piercing ammunition, with reference to the standard EN 1522-1523, from level FB5 upwards.

With regard to ballistic helmets, two main functional elements are used for their production: thermosetting or thermoplastic matrix aramid pre-pregs, and polyethylene fiber unidirectional pre-pregs.

A multilayer of said materials forms the final helmet which can be configured monolithically or alternatively as a combination of aramid and polyethylene unidirectional pre-pregs, according to the performance required regarding a given reference standard.

The present invention concerns in particular a material that belongs to the category of aramid pre-pregs.

According to the production process of the final article, it is possible to choose from the following prior art technologies, which provide two types of products:
thermosetting pre-pregs, by means of a process of hot coating and transfer of phenolic resins or, less commonly, epoxy or other types of resins, on the fabric;
thermoplastic pre-pregs, by direct lamination of thermoplastic films on the fabric.

Consequently, the configuration of the pre-preg produced is in both cases characterized by the presence of two elements: the base fabric and a plastic matrix.

Typically, with respect to the world of composites, the main difference lies in the different matrix/fabric ratio depending on the performance required.

Within this category, for years phenol-based matrixes have been the main solution since, with the same fabric, they guarantee high performance in a stable manner over time and also after application of many different conditioning cycles on the final article.

On the other hand, the presence of formaldehyde, sometimes only in traces nowadays, and the inevitable presence of phenol, makes this system incompatible with the growing demand for “green” and/or recyclable products which is affecting every aspect of our daily lives.

Vice versa, the thermoplastic pre-pregs, which however do not guarantee the same performance, would allow a greater selection of basic chemical components to meet this growing ecological requirement.

Looking at these pre-pregs in terms of the process for production of the final article, there are significant differences downstream.

Both cases entail the cutting of different layers to form the panel constituting the final article, thanks to overlapping of said layers, following a specific design, and application of a temperature and pressure cycle in autoclave or in a press mold.

This panel formation cycle of the prior art stands out for two categories:
thermosetting pre-pregs: a “hot-hot” fast cycle at high pressure and fixed high temperature (between 130° C. and 200° C. according to the resin system) lasting 12′-30′; insertion and extraction are carried out at high temperature;
thermoplastic pre-pregs: a “(cold-)hot-cold” averagely slow cycle where the essential stages are the permanent application of a high pressure from the moment when the mold/autoclave is closed and a peak temperature, lasting from 10′ to 60′ between 100 and 200° C. according to the type of matrix, until cooling of the article to below the glass transition temperature Tg of the matrix.

The publication US 2016/0281272 A1 describes a composite material for ballistic applications, which comprises a bimodal binder.

### SUMMARY OF THE INVENTION

The aim of the present invention is to provide a pre-preg useful for the preparation of ballistic protection panels and a method for the production thereof, different from the conventional coating/lamination treatments.

Within this aim, an object of the invention is to provide a material that ensures a virtually infinite shelf life at room temperature, unlike the phenol-based pre-pregs which more traditionally at room temperature have a shelf life in the order of days/weeks.

Another object of the invention is to provide a material with advantageous storage conditions limited to the need to guarantee dark packaging that protects against ambient humidity and UV radiations.

A further object of the present invention is to provide a material and a production method that allow high versatility in definition of the product configuration, in particular as regards the amount of matrix added to the support.

Yet another object of the invention is to provide a material that allows great versatility in processing by the user.

A further object of the present invention is to provide a material that enables the production of a high-performance final article.

A further object of the invention is to provide a material that guarantees optimal safety and is environment-friendly thanks to the starting elements and the technology used, avoiding the presence of solvents and halogen-based components.

A further object of the present invention is to provide a material that is compatible with the other existing technologies.

These and other objects, which will be further illustrated below, are achieved by a protective material and a method for the production thereof, as claimed in the appended claims.

### BRIEF DESCRIPTION OF THE DRAWINGS

Further characteristics and advantages of the subject of the present invention will become clearer from the description of a preferred but non-exclusive embodiment of the invention, illustrated by way of non-limiting example in the attached drawings, in which:

FIG. 1 is a schematic view illustrating an example of a plant for production of the composite material or pre-preg according to the invention;

FIGS. 2-5 illustrate the performance data of an embodiment of the panel produced with the composite material according to the present invention;

FIGS. 6-7 illustrate a comparison of the performances of a panel molded from eighteen layers of composite material according to the invention, compared to a conventional phenol-based product;

FIGS. 8 and 9 illustrate in perspective the pre-preg subject of the invention and the structure of the multilayer panel molded from several layers of said pre-preg, respectively.

### DETAILED DISCLOSURE OF PREFERRED EMBODIMENTS

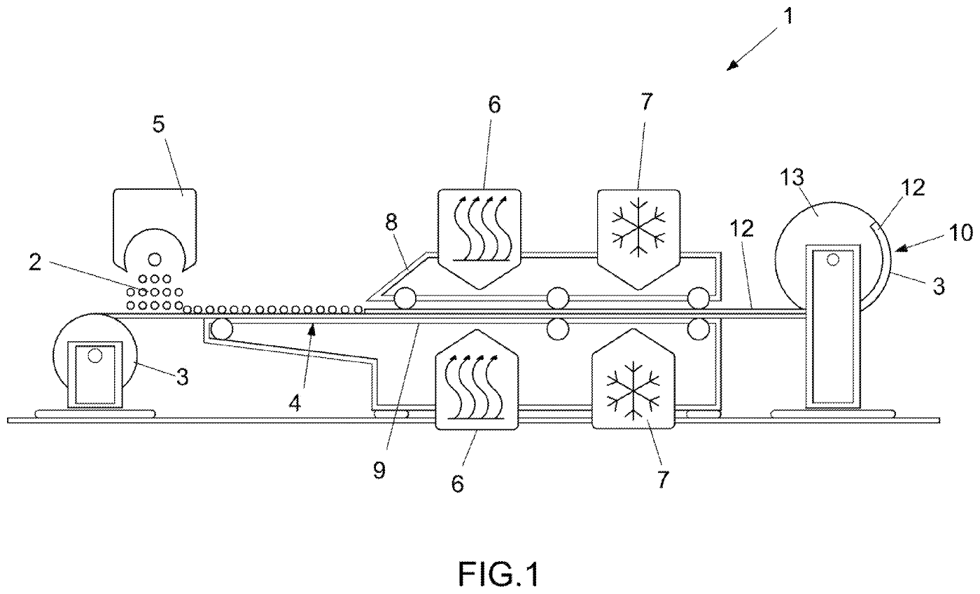

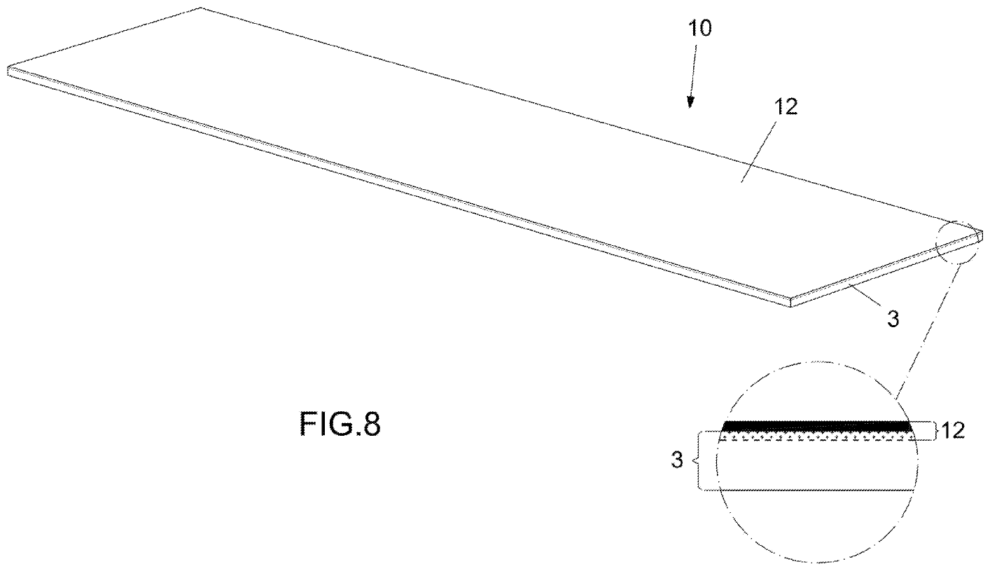

With particular reference to the numeric symbols of the above-mentioned figures, the production method of the composite material or pre-preg 10 of the invention illustrated in FIG. 8 is carried out by means of a plant, schematically illustrated in FIG. 1 and indicated as a whole by the reference number 1.

According to the present invention, a thermoplastic matrix or amorphous or non-crystalline surface thermoplastic film 12 is produced from a micrometric powder 2 of thermoplastic material which is dry distributed, by means of a powder scattering station 5, over the whole surface or the entire upper face of an aramid fabric 3 as it is unwound over a conveyor belt 4.

This deposition is followed by entry of the powder 2, thus distributed, into the heart of the production line, formed of a system of double belts in contact, split into two sections, thanks to which the material moves forward along the line: a first hot section 6 and a second relatively cold section 7.

The first section 6 applies to the powder 2 a temperature ranging from 100 to 250° C. and a pressure from 0.1 N/cm² to 200 N/cm²—according to the chemical-physical characteristics of the powder used—functional to the formation of said amorphous surface thermoplastic film 12, by melting of the powder 2 over the fabric 3. The film 12 then adheres to the upper face of the fabric 3, also by partial interpenetration inside the fibers of said fabric, thus forming a flexible pre-preg 10 wound in the form of a roll 13 (FIG. 8).

The amorphous thermoplastic resin that has formed on the surface or on the upper face of the fabric 3 forms a matrix or a film which is partially interpenetrated on said surface, thus leaving a thickness of matrix which is available for adhesion of the other elements forming the multilayer panel.

The second section 7 facilitates detachment of the material from the belts, by cooling to a temperature preferably below the melting or glass transition temperature of the film 12.

The double belt system comprises an upper belt 8 and a lower belt 9, the initial portion of which coincides with the conveyor belt 4. According to the present invention the thermoplastic film 12 is partially interpenetrated and well-adhered to the fabric 3, uniform and with good cohesion, with the desired basis weight obtained according to the speed of the line and the settings of the scattering head 5.

According to the invention, the fabric 3 is a flexible fabric in a roll for ballistic application made from para-aramid, glass, polyethylene (UHMWPE) or polypropylene fibers with denier from 220 to 3300 dtex.

The thermoplastic matrix 2 is obtained from a powder preferably based on polyesters, polyethers, polyolefins, polyvinyl butyral, polyurethanes and any derivatives or combinations thereof, having powder diameter distribution ranging from 0.1 to 750 μm.

The powder scattering system 5 associated with the double belt system, according to the invention, enables a choice totally free of constraints regarding the amount of powder 2 added to the support 3.

The present invention, in fact, allows the basis weight of the powder 2 to be adjusted from 20 to 250 g/m², in one single step.

The thermoplastic pre-preg 10 produced according to the present invention enables production—by means of a temperature molding process of several overlapped layers—of the functional part of ballistic protection helmets and multilayer laminates used for vehicle armoring.

It provides great versatility in the final processing of the cited panels, guaranteeing consolidation of the article thanks to the application of thermal cycles, with peak temperatures ranging from 115 to 200° C., applying pressures between 10 and 100 bar to obtain good rigidity.

Typically, the duration of the isotherm at the peak temperature will depend on the number of layers used to make the panel, with the main aim of obtaining an article free from delamination.

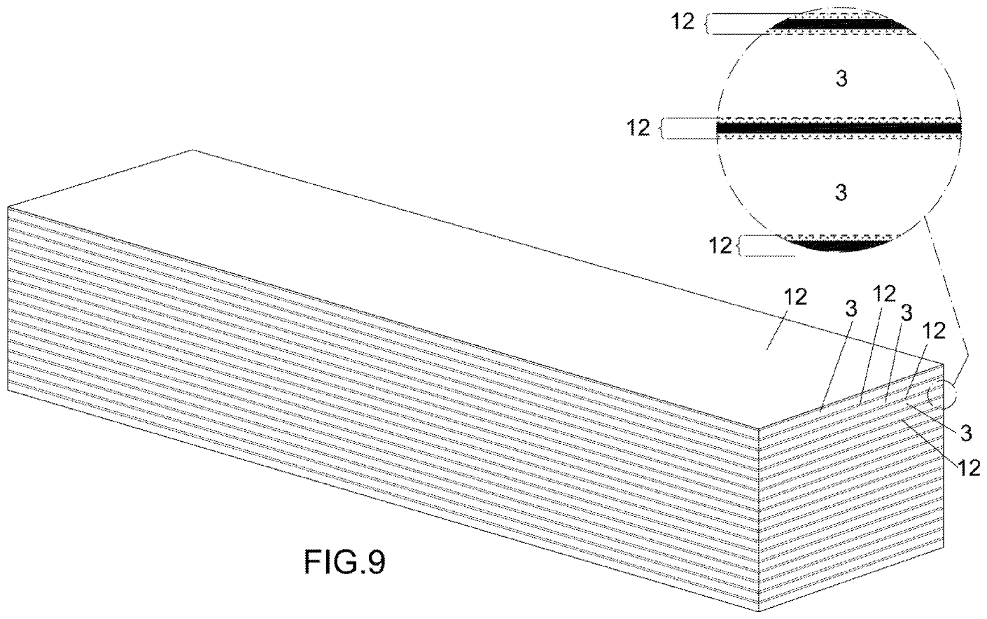

In particular, according to the example of FIG. 9, with the pre-preg 10 of the invention it is possible to produce a panel 11 with eighteen layers of pre-preg 10, joined to one another in one single panel 11 by application of a cold-hot-cold compression cycle with a peak isotherm preferably between 115 and 180° C. and pressures between 5 and 100 bar.

The need to cool the molds to below 70° C. in order to maintain the form of the panels is a constant of the process.

To summarize, there are two very wide intervals—of isotherm temperature and pressure—within which it is possible to use the pre-preg 10, without a significant variation in the overall ballistic performances of the panels 11 obtained from the set of said overlapped and molded pre-pregs.

In the utilization phase, this entails evident production advantages in terms of versatility of said panel 11, compared to the downstream process for the production of articles.

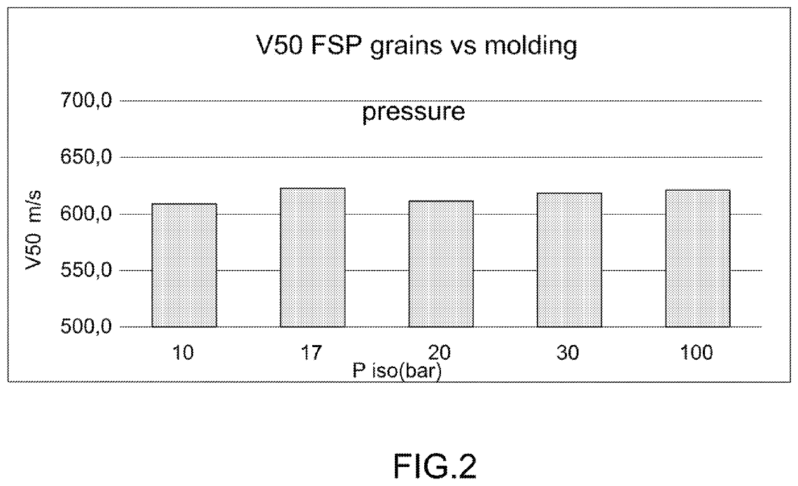

Analyzing the subject of the present invention in further detail, FIGS. 2 to 5 refer to the ballistic performances of the planar panel 11 of FIG. 9, formed of eighteen layers of 400 g/m² para-aramid fabric with 12% thermoplastic matrix 12.

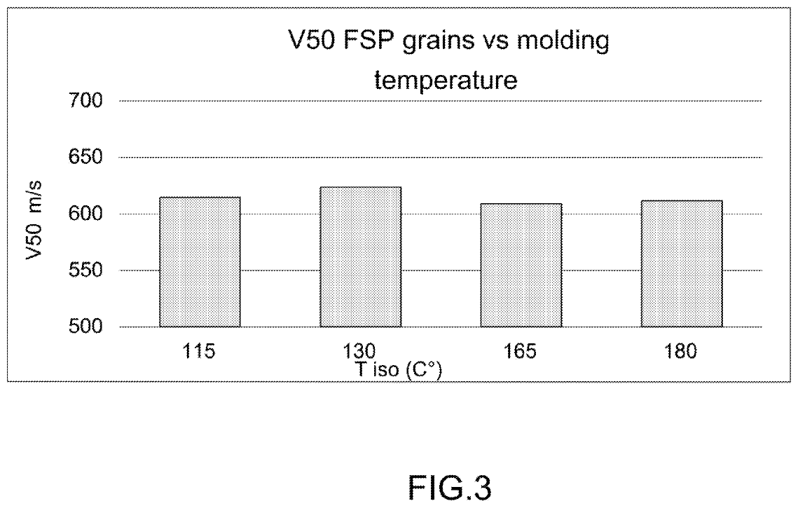

Specifically, FIGS. 2 and 3 illustrate the V50 performances (17 g FSP in accordance with the Stanag 2920 standard), in which:

FIG. 2 shows the stability of the V50s detected on the panel 11 as the pressure applied constantly throughout the cycle varies (from 10 to 100 bar);

FIG. 3 shows the stability of the V50s detected on the panel 11 as the cycle temperature at the peak isotherm varies (from 115 to 180° C.).

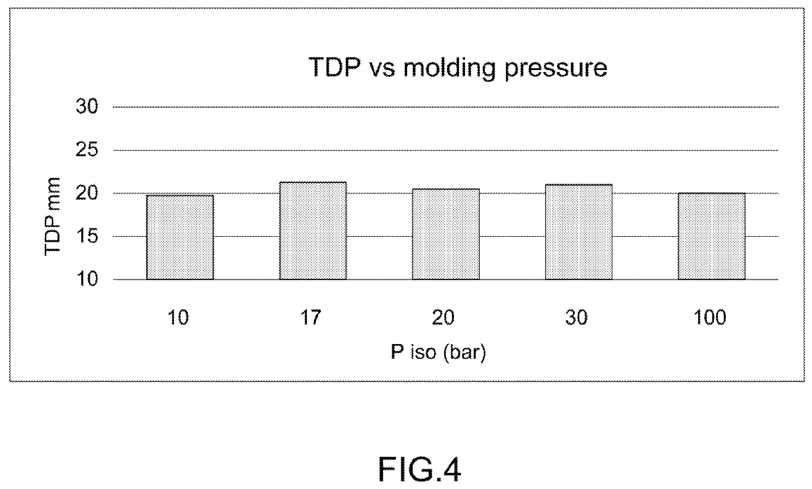

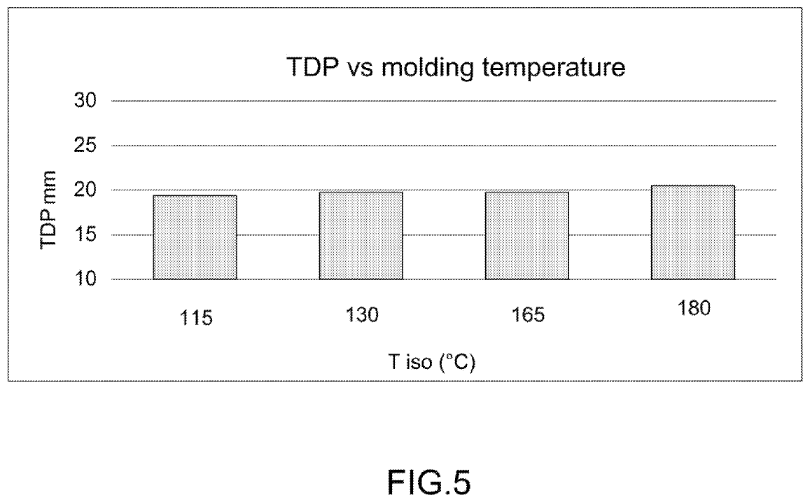

FIGS. 4 and 5 illustrate the performances of the panel 11 with respect to a VO test (9 mm projectile in accordance with the NIJ 0101.04 standard). This test entails positioning said panel on the surface of a frame containing clay in accordance with the mentioned standard, firing the projectile at a velocity of (436±9) m/s from a distance of 5 m and measuring the depth of the impression left on the clay at the back (TDP=impact trauma) due to the impact of the projectile against the surface of the panel 11.

In particular:

FIG. 4 shows the consistency of the trauma values on clay as the pressure applied constantly throughout the cycle varies (from 10 to 100 bar);

FIG. 5 shows the consistency of the depth values of the impression left on clay as the cycle temperature at the peak isotherm varies (from 115 to 180° C.).

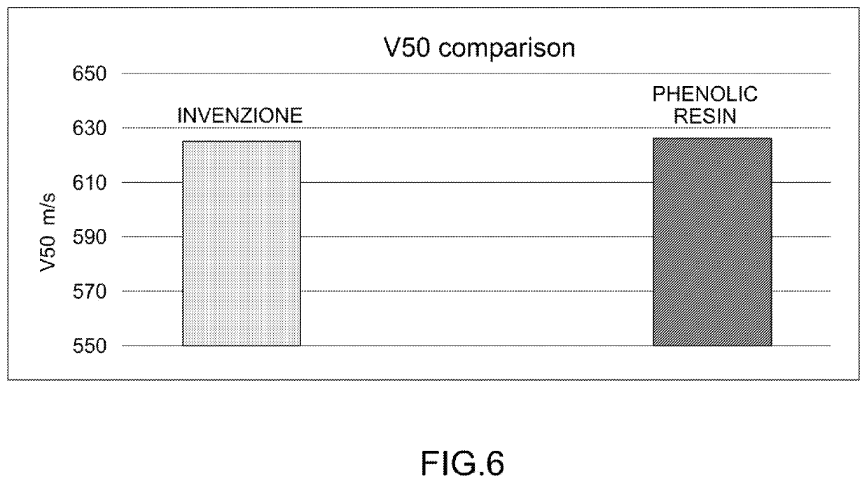

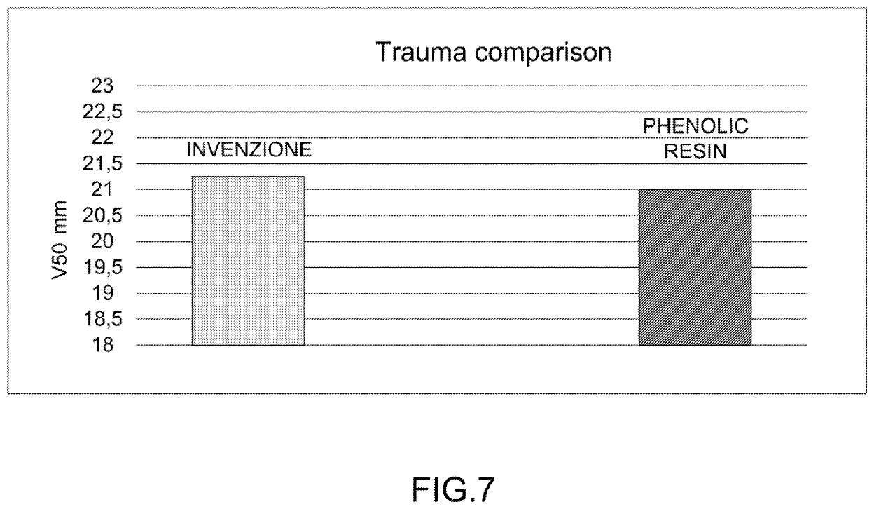

FIGS. 6 and 7 illustrate a comparison between the V50 performances (17 g FSP in accordance with the Stanag 2920 standard) and impact deformation on clay following VO test (Remington 9 mm projectile in accordance with the NIJ 0101.04 standard) of the multilayer panel 11 of the invention and an analogous product obtained from a pre-preg based on conventional phenolic matrix.

FIG. 8 illustrates in perspective the composition of the pre-preg 10 obtained with the process of the invention. It is composed of a base fabric 3, on the surface or upper face of which the matrix 12, formed of the micrometric powder 2 which has been melted and compacted over the same fabric 3 and which is adhered and partially interpenetrated thereon, is deposited.

FIG. 9 illustrates in perspective a multilayer panel 11 molded with a (cold-)hot-cold pressure/temperature cycle from eighteen layers of the pre-preg 10, where it can be observed that the thermoplastic matrix 12 is interleaved and partially interpenetrated layer after layer with the adjacent fabrics 3.

The following table shows some advantageous embodiments of the invention, among the various possible matrix/fabric combinations, where:
the aramid fiber constituting the fabric 3 has denier 670, 940, 1100, 1320, 3140, 3300 dtex;
the content of matrix 2 relative to the fabric 3 is between 5 and 40% for all the deniers according to the final application, preferably 40% for the lower deniers (670 and 930 dtex);
filming of the powders is performed on one or both sides according to the final application.

The table shows an example list of products, with thermoplastic matrix suitable for use in the production of ballistic helmets.

| | | | | Area | | Role of pre- |
|---|---|---|---|---|---|---|
| | Fiber | | | density | | preg in |
| | denier | Fabric | | [kg/m²]- | V50 | production |
| Product | (dtex) | weave | Matrix % | #layers | [m/s] | of helmets |
| # 1 | 3140 | Plain | 12 | 8.2-18 | 628.4 | Functional |
| # 2 | 930 | Panama | 9 | 7.1-19 | 617.7 | ballistic |
| | | 3/3 | | | | part |
| # 3 | 3300 | Plain | 11 | 8.9-18 | 654.7 | (monolithic) |
| # 4 | 670 | Plain | 20 (2 | 1 or 2 | — | Innermost |
| | | | sides) | | | layer and/or |
| # 5 | 1100 | Plain | 18 (2 | 1 or 2 | — | outermost |
| | | | sides) | | | layer of the |
| # 6 | 3140 | Plain | 21 (2 | 1 or 2 | — | article |
| | | | sides) | | | |

The products #1 to #3 constitute example pre-pregs for the production of a “monolithic” planar article—i.e. made exclusively of layers of the same pre-preg 10 of the invention—representative for a helmet.

The products #4 to #6 are example pre-pregs having the sole function of being used as an inner and outer layer, where the ballistic part of the helmet consists of high-performing materials of other types (i.e. polyethylene unidirectionals), meeting the need to give the article an outer surface compatible with the paints traditionally used in this field.

The pre-preg according to the present invention is obtained by means of a technology substantially different from a conventional coating/lamination and offers a number of important advantages.

According to the present invention, the starting thermoplastic matrix is in the form of a micrometric powder and is distributed over the whole upper surface of an aramid fabric, as the fabric itself is unwound over the conveyor belt, thanks to the use of a powder scattering station.

This deposition is followed by entry of the material into the heart of the production line, formed of a system of double belts in contact, split into two sections, by means of which the material is conveyed along the line.

According to the present invention the film is partially interpenetrated and well-adhered to the fabric, uniform and with good cohesion, with the desired basis weight according to the speed of the line and settings of the scattering head.

As for most of pre-pregs with thermoplastic matrix, the shelf life of the product according to the present invention is theoretically infinite at room temperature, unlike the conventional phenol-based pre-pregs which, at room temperature, have a shelf life in the order of days/weeks.

This reflects on the storage conditions which, like all pre-pregs with thermoplastic matrix, only require, due to the presence of the aramid fabric, dark packaging that protects against ambient humidity and UV radiations which can alter the mechanical properties of the fiber.

The phenol-based pre-pregs, on the other hand, require controlled low temperature cold stores for long-term storage of the material so as to maintain processability and, consequently, adequate performance.

A further advantage of the present invention consists in its versatility in definition of the product configuration.

The powder scattering system associated with the double belt system allows a choice totally free from constraints regarding the amount of matrix added to the support.

In fact, there are two aspects to be considered.

The conventional phenolic pre-pregs used in ballistics are systems produced from solvent resins, the resin content of which is determined to guarantee the performance of the subsequently molded product.

The basis weight can be chosen on a continuous scale, however above given amounts (from 20 gsm to approximately 80 gsm) the control over the process in order to obtain uniform impregnation becomes very difficult.

For this reason, whenever is possible, multiple impregnation steps are used, with consequent significant increase in costs.

The product according to the present invention, on the other hand, enables theoretical adjustment of the basis weight from 20 to 250 g/m² in one single step. In the same way, the coupling on two sides by means of a conventional system can be a difficult and expensive operation, whereas with the present invention the coupling on two sides can be carried out easily and with a limited increase in costs since use of the thermoplastic powder 2 allows a choice of temperatures and pressures in the section 6 which in the coating phase on the second side do not alter what has already been deposited on the opposite side.

The conventional thermoplastic pre-pregs are made from films with specific basis weight (more commonly 50-100 g/m², sometimes 25-75-125 g/m²), a limiting factor with regard to the choice of the matrix content which often does not allow simultaneous adoption of the “best” fabric and choice of the optimal resin content to meet a required performance. With the process of the present invention, this condition is overcome, since basis weights from 20 to 250 g/m² can be chosen without gaps on a continuous basis.

A further important advantage of the present invention concerns the versatility of processing by the end user.

It is important to underline that consolidation of the helmet or the article in general with the thermoplastic pre-preg according to the present invention is possible with peak temperatures ranging from 110 to 200° C., applying pressures between 10 and 100 bar to obtain good rigidity.

Typically, the duration of the isotherm at the peak temperature depends on the number of layers used to make the product and the type of performance required. The need to cool the molds to below 70° C. in order to maintain the form is a constant of the process.

A further advantage consists in the fact that with the thermoplastic pre-preg produced according to the present invention, the performances of the conventional phenolic pre-pregs can be achieved, once the final article has been produced.

In fact, the data collected show stability also following conditioning tests typical of the application environments considered.

A further advantage of the present invention consists in the fact that the starting elements and the technology used are free from the presence of solvents and halogen-based components.

Consequently, both in the production phase and in the molding phase at the end manufacturer's works and at the time of use of the end article, there is no possibility of contamination.

A further advantage of the invention is represented by the compatibility with other existing technologies: the need for application of a longer cycle (cold-)hot-cold is analogous to and compatible, in terms of temperatures and pressures that can be used, with that of unidirectional polyethylene, the main material on the market for the production of armoring and helmets.

In the production of hybrid articles, namely layers of aramid pre-preg and unidirectional PE in one single solution, the matrix allows adhesion also to the interface with the latter.

In practice it has been found that the invention achieves the intended aims and objects.

1. A process for the production of a fiber-reinforced composite material (10), characterized in that it comprises the steps of:
unwinding an aramid fabric (3) on conveyor means;
dry distributing a micrometric powder (2) of thermoplastic material on the surface of said aramid fabric (3);
heating to the melting temperature and compressing said powder (2) on the cited surface of the fabric (3) so as to form on it an amorphous thermoplastic matrix (12) partially interpenetrated and adhered to said fabric (3) as it is unwound;
cooling the composite material (10) thus obtained, to facilitate detachment of the latter from said conveyor means.

2. The process according to claim 1, characterized in that said powder (2) is heated to a temperature from 100 to 250° C. and is subsequently compressed at a pressure ranging from 0.1 N/cm² to 200 N/cm².

3. The process according to claim 1, characterized in that said cooling of the composite material (10) is carried out below the melting or glass transition temperature of said thermoplastic matrix (12).

4. A fiber-reinforced composite material produced with the process according to claim 1, characterized in that it comprises an amorphous thermoplastic matrix (12) distributed on the surface of an aramid fabric (3), thus forming a surface thermoplastic film partially interpenetrated with and adhered to said aramid fabric.

5. A plant for carrying out the process and producing the fiber-reinforced composite material according to claim 1, characterized in that it comprises a conveyor belt (4) on which an aramid fabric (3) is unwound; a powder scattering station (5) adapted to distribute a micrometric powder (2) on said aramid fabric (3) as it is unwound on said conveyor belt (4); a system of double belts in contact (8,9), split into two sections, through which said fabric (3) is conveyed; said system of double belts in contact defining a first hot section (6) and a second relatively cold section (7); said first section (6) applying a temperature and a pressure functional to the formation of an amorphous thermoplastic matrix (12) on the surface of said fabric (3); said second section (7) performing cooling to below the glass transition temperature of said polymer matrix (12).

6. The plant, according to claim 5, characterized in that said double belt system comprises an upper belt (8) and a lower belt (9), acting on said fabric (3) and on said amorphous polymer matrix (12), providing adhesion to and partial interpenetration of the latter with said fabric (3).

7. A multilayer panel for ballistic applications, characterized in that it is made of the composite material and with the process according to claim 1.

8. The panel according to claim 7, characterized in that it comprises a plurality of layers of composite material (10), combined with one another in one single panel (11) by application of a cold-hot-cold compression cycle with a peak isotherm preferably ranging from 115 to 180° C. and pressures between 5 and 100 bar, followed by a cooling phase.

9. The panel according to claim 8 for use in the manufacture of helmets and ballistic armoring in general.
